(19) United States
(12) Patent Application Publication
(10) Pub. No.: US 2013/0004128 A1
(43) Pub. Date: Jan. 3, 2013

(54) Expanded beam fiber optic connector system

(76) Inventor: Wade F.M. Zhang, Carpentersville, IL (US)

(21) Appl. No.: 13/135,237

(22) Filed: Jun. 29, 2011

(51) Int. Cl. G02B 6/36

(52) U.S. Cl. 385/79

(57) ABSTRACT

The device which enables a physical contact fiber optic connector into an expanded beam connector includes a fiber stub, an aspherical lens, and a housing. The fiber stub includes a stub body and a discrete length of optical fiber retained by the stub body. The housing retains the fiber stub and the aspherical lens so that the discrete length of optical fiber of the fiber stub is in optical communication with the aspherical lens.

### BACKGROUND OF THE INVENTION

1. Field of the Invention

The present invention pertains to fiber optic connectors. The invention more particularly concerns a fiber optic connector system which enables a user to convert a physical contact, fiber optic connector into an expanded beam, fiber optic connector.

2. Discussion of the Background

Fiber optic connectors and cables are known in the art. Typically, a fiber optic cable is terminated at each end by a respective fiber optic connector. At least two categories of fiber optic connectors exist and include physical contact connectors and expanded beam connectors. In practice, a fiber optic cable terminated with physical contact connectors will only connect to other fiber optic cables which are also terminated with physical contact connectors. Likewise, in practice, a fiber optic cable terminated with expanded beam connectors will only connect to other fiber optic cables which are also terminated with expanded beam connectors.

Physical contact connectors are characterized as such since one end of a ferrule of a first fiber optic connector physically contacts one end of a ferrule of a second fiber optic connector. Light exiting the core of the optical fiber held within the ferrule of the first fiber optic connector is then immediately introduced into the core of the optical fiber held within the ferrule of the second fiber optic connector. If the two cores are misaligned by more than a whole number of diameters of the core of the optical fiber, then most of the optical power is not exchanged from the core of the first fiber optic connector to the core of the second fiber optic connector. If a piece of debris is caught between the core of the first fiber optic connector and the core of the second fiber optic connector, then it is probable that no optical power will be exchanged from the core of the first fiber optic connector to the core of the second fiber optic connector, assuming that the debris has a size which is approximately the same size or larger than the size of the core of one of the optical fibers. Examples of physical contact connectors are set forth in U.S. Pat. Nos. 5,481,634, and 6,234,683. U.S. Pat. Nos. 5,481,634, and 6,234,683 are hereby incorporated herein by reference. Over time, the industry has utilized many physical contact, single fiber, fiber optic connectors as standards or styles, such as the LC, FC, ST, and SC fiber optic connectors.

FIG. 1 is a perspective view of one type of physical contact, single fiber, fiber optic connector 10. The fiber optic connector 10 includes a ferrule 12. Also shown is an optical cable 16. The fiber optic connector 10 generally conforms to the LC-style fiber optic connector. The ferrule 12 conforming to the LC-style has an outside diameter of approximately 1.25 millimeters. FIG. 2 is an exploded, perspective view of the fiber optic connector 10 of FIG. 1. Further shown in FIG. 2 is the optical fiber 14 of the optical cable 16. Also, the ferrule 12 is more clearly shown. FIG. 3 is a partial cross-sectional side view of two fiber optic connectors 10, 20, and two receptacles 18, 19. Fiber optic connector 10 is shown in partial cross-section, but the ferrule 12 is shown in side view. The other fiber optic connector 20 and the two receptacles 18, 19 are shown in cross-section. Receptacle 18 is attached to receptacle 19. Each receptacle 18, 19 is adapted to receive of fiber optic connector that conforms to the LC-style. Also shown is the physical contact between the ferrule 12 of the one fiber optic connector and the ferrule 22 of the other fiber optic connector 20.

FIG. 4 is a perspective view of three different types or styles of physical contact, single fiber, fiber optic connectors. A flat panel 24 contains three openings. The first opening is a receptacle 26 which accommodates two SC-type fiber optic connectors 32, 33, the second opening is a receptacle 28 which accommodates two FC-style fiber optic connectors 34, 35, and the third opening is a receptacle 30 which accommodates two ST-style fiber optic connectors 36, 37. The ferrules of the fiber optic connectors 32, 33, 34, 35, 36, 37 have an outside diameter of approximately 2.5 millimeters. FIGS. 1, 2, 3, and 4 are illustrations derived from figures found U.S. Pat. No. 5,481,634.

Expanded beam connectors are characterized as such since the optical fiber of the fiber optic cable is mated with a lens, typically a ball lens. The expanded beam fiber optic connector holds the terminated end of the optical fiber adjacent to the lens. When optical power exits the core of the optical fiber, the optical power then enters the lens, and then eventually exits the lens. The lens causes the optical power, or light, to diverge or expand before the optical power exits the fiber optic connector. If a second expanded beam fiber optic connector is attached to the first expanded beam fiber optic connector, then, after the optical power exits the first expanded beam fiber optic connector in the expanded state, the optical power will enter the second expanded beam fiber optic connector. The optical power will enter the lens of the second expanded beam fiber optic connector and then exit the lens. The lens of the second expanded beam fiber optic connector causes the optical power to converge. The focal point of the lens of the second expanded beam fiber optic connector is centered at the core of the optical fiber of the second fiber optic cable so that substantially all of the optical power exiting the lens enters the optical fiber. If the two cores are misaligned by less than a whole number of diameters of the core of the optical fiber, then most of the optical power is exchanged from the core of the first fiber optic connector to the core of the second fiber optic connector. If a piece of debris is caught between the lens of the first fiber optic connector and the lens of the second fiber optic connector, then it is probable that some of the optical power will be exchanged from the core of the first fiber optic connector to the core of the second fiber optic connector, assuming that the debris has a size which is approximately the same size or larger than the size of the core of one of the optical fibers but is smaller than the diameter of the expanded beam. Examples of expanded beam connectors are set forth in U.S. Pat. No. 5,247,595. U.S. Pat. No. 5,247,595 is hereby incorporated herein by reference.

FIG. 5 is a cross-sectional side view of an expanded beam connector 40 that includes an optical fiber 41 and a lens 42. FIG. 6 is a cross-section side view of two expanded beam connectors 10, 43 which are readied for optical communication with one another. FIGS. 5, and 6 are illustrations derived from figures found U.S. Pat. No. 5,247,595.

Another type of expanded beam device exists which is an optical fiber that includes a collimator portion. Such a device is disclosed in U.S. Pat. No. 7,155,096. U.S. Pat. No. 7,155,096 is hereby incorporated herein by reference.

Accordingly, there is a need for a device which enables a known physical contact fiber optic connector to be converted into an expanded beam fiber optic connector so that advantages of the expanded beam connector can be exploited by a physical contact connector.

### SUMMARY OF THE INVENTION

It is an object of the invention to provide a device which enables a user to convert a physical contact, fiber optic connector into an expanded beam, fiber optic connector.

It is a further object of the invention to provide a device which includes expanded beam technology and which can accommodate a ferrule which conform to an industrial standard which is based on physical contact, fiber optic connector technology.

It is another object of the invention to provide a device that includes expanded beam technology which accommodates a LC-style fiber optic connector.

It is another object of the invention to provide a device that includes expanded beam technology which accommodates a SC-style fiber optic connector.

It is another object of the invention to provide a device that includes expanded beam technology which accommodates a FC-style fiber optic connector.

It is another object of the invention to provide a device that includes expanded beam technology which accommodates a ST-style fiber optic connector.

In one form of the invention the device includes a fiber stub, an aspherical lens, and a housing. The fiber stub includes a stub body and a discrete length of optical fiber retained by the stub body. The housing retains the fiber stub and the aspherical lens so that the discrete length of optical fiber of the fiber stub is in optical communication with the aspherical lens.

In a second form of the invention the device includes a fiber stub, an aspherical lens, a housing, and a sleeve. The fiber stub includes a stub body and a discrete length of optical fiber retained by the stub body. The housing retains the fiber stub and the aspherical lens so that the discrete length of optical fiber of the fiber stub is in optical communication with the aspherical lens. The sleeve has an outside diameter, and the sleeve is mounted to the stub body of the fiber stub.

In a third form of the invention the device includes a fiber stub, an aspherical lens, a housing, and a sleeve. The fiber stub includes a stub body and a discrete length of optical fiber retained by the stub body. The housing retains the fiber stub and the aspherical lens so that the discrete length of optical fiber of the fiber stub is in optical communication with the aspherical lens. The sleeve has an outside diameter, and the sleeve is mounted to the stub body of the fiber stub. The inside diameter of the sleeve is adapted to receive a ferrule which conforms to an industrial standard selected from the group consisting of LC, SC, FC, and ST industrial standards.

Thus, the invention achieves the objectives set forth above. The invention provides a device, converter, or system which includes expanded beam technology, yet is mateable with or connectable to ferrules or connectors that are physical contact, fiber optic connectors such as LC, SC, FC, and ST style fiber optic connectors.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of one type of a known physical contact, fiber optic connector;

FIG. 2 is an exploded, perspective view of the known fiber optic connector of FIG. 1;

FIG. 3 is a partial cross-sectional side view of a known assembly which includes the known physical contact, fiber optic connector of FIG. 1 and another physical contact, fiber optic connector and two receptacles, where each of the physical contact, fiber optic connects are positioned so as to enable optical communication between each of the two physical contact, fiber optic connectors;

FIG. 4 is a perspective view of three different types or styles of known physical contact, fiber optic connectors;

FIG. 5 is a cross-sectional side view of a known expanded beam, fiber optic connector;

FIG. 6 is a cross-sectional side view of a known assembly which includes the known expanded beam, fiber optic connector of FIG. 5 and another expanded beam, fiber optic connector where each of the expanded beam, fiber optic connectors are positioned so as to enable optical communication between each of the two expanded beam, fiber optic connectors;

FIG. 7 is a cross-sectional side view of the device or expanded beam converter of the invention;

FIG. 8 is a cross-sectional side view of a known physical contact, fiber optic connector;

FIG. 9 is a cross-sectional side view of the physical contact, fiber optic connector of FIG. 8 engaged or mated with the device of FIG. 7;

FIG. 10 is a cross-sectional side view of the stub collimator of the device of FIG. 7;

FIG. 11 is an exploded, cross-sectional side view of the fiber stub of the stub collimator of FIG. 10; and

FIG. 12 is an exploded, cross-sectional side view of the aspherical lens of the stub collimator of FIG. 10.

### DETAILED DESCRIPTION OF THE PRESENTLY PREFERRED EMBODIMENTS

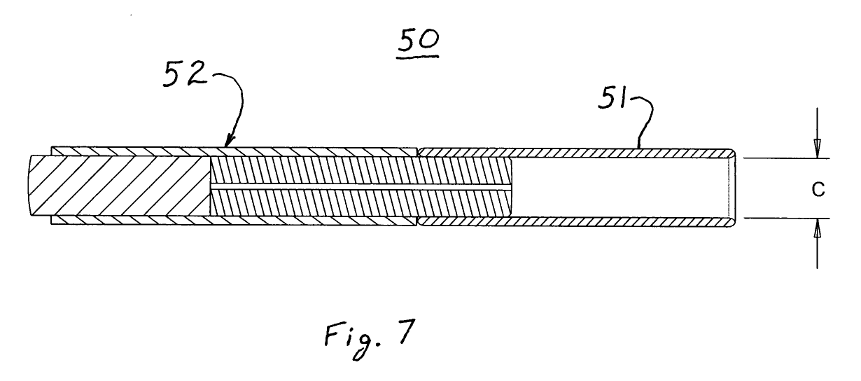

Referring now to the drawings, wherein like reference numerals designate identical or corresponding parts throughout the several views, and more particularly to FIGS. 7, and 9-12 thereof, embodiments of the present invention is a device, convertor, or system 50 for converting a physical contact, fiber optic connector into an expanded beam, fiber optic connector which is displayed therein.

FIG. 7 is a cross-sectional side view of the device 50. The device 50 includes a stub collimator 52 and a sleeve 51. The sleeve 51 is adapted for receiving a ferrule of a physical contact, fiber optic connector. The sleeve 51 includes an inside diameter that is identified by alphabetic character C. The inside diameter C of the sleeve 51 is adapted for receiving the ferrule of a physical contact, fiber optic connector.

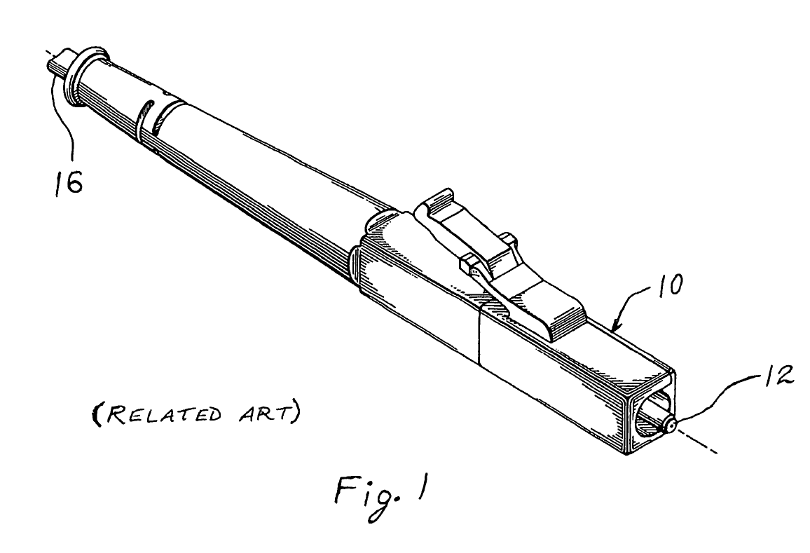

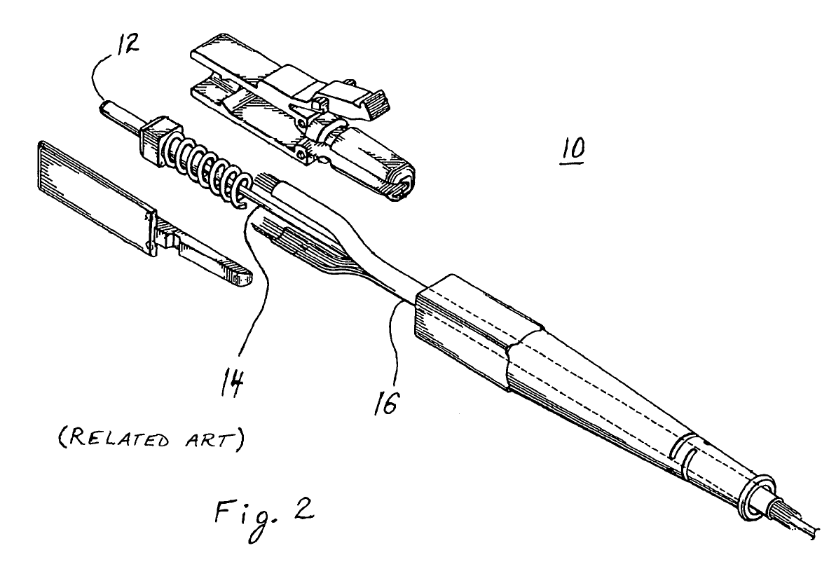

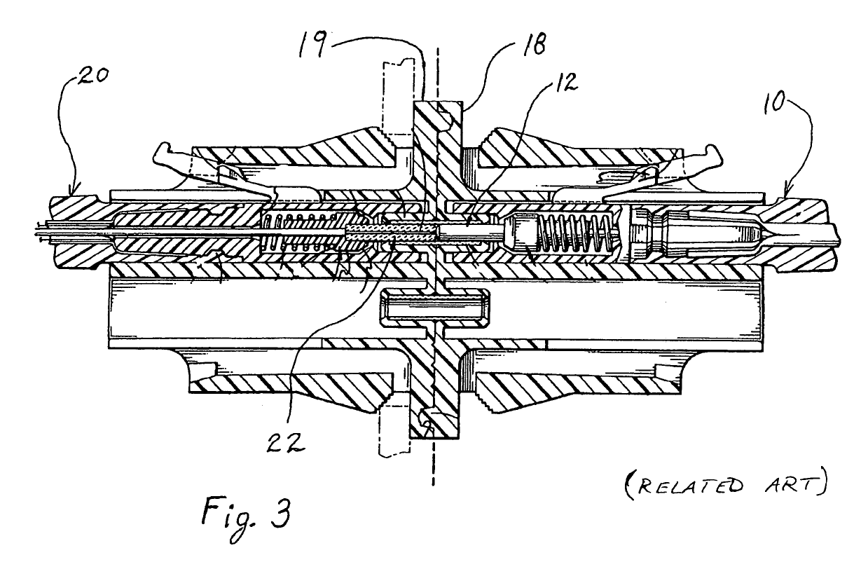

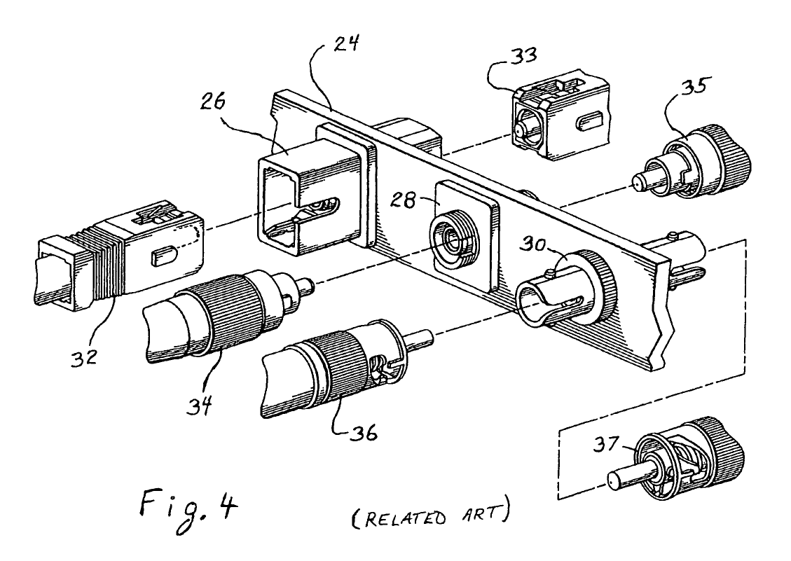

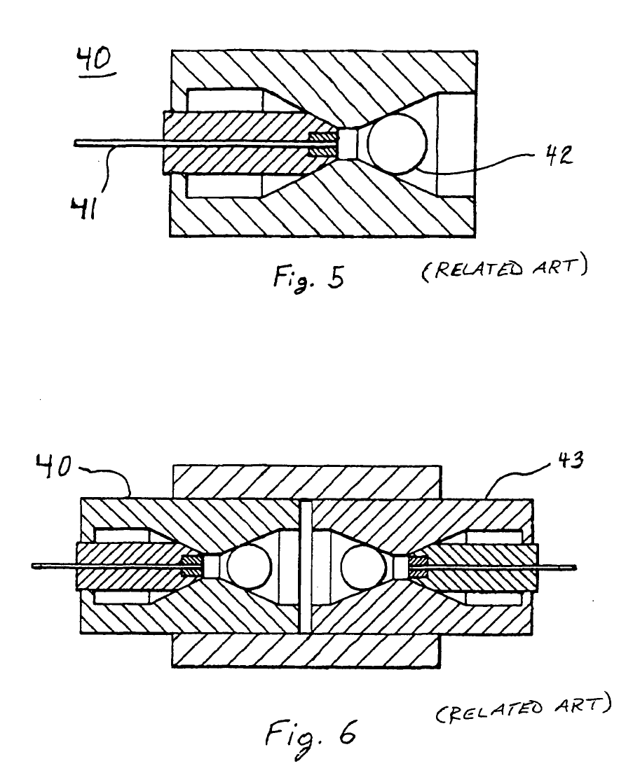

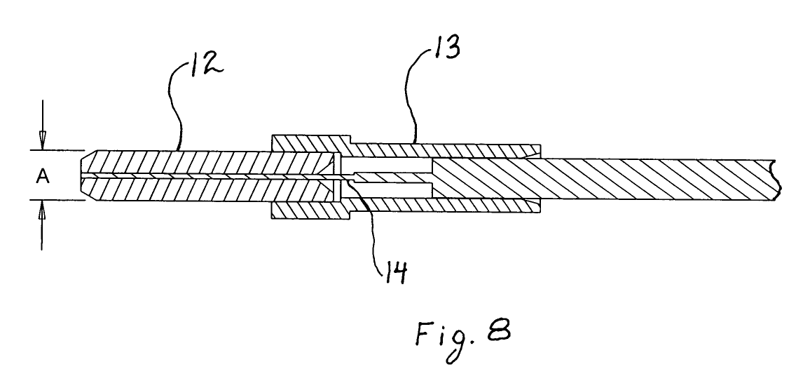

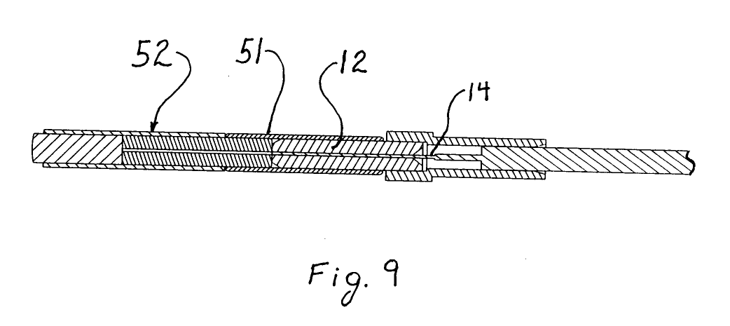

FIG. 8 is a cross-sectional side view of a the ferrule 12 and optical fiber 14 of the physical contact connector displayed in FIGS. 1 and 2 without displaying the connector structure that forms the latching mechanism. Also shown in FIG. 8 is a ferrule holder 13. The ferrule 12 of the connector shown in FIG. 8 can have no connector body, or it can have a connector body as shown in FIG. 1, or it can have a connector body as shown in FIG. 4, or it can have any other shaped connector body. The ferrule 12 further includes an outside diameter identified by alphabetic character A. The outside diameter A of the ferrule 12 can be of any size, but for the ferrule 12 to conform to the standard of an LC connector the ferrule has an outside diameter A which is substantially equal to 1.25 millimeters, and if the ferrule 12 is to conform to the SC, ST, and FC standards then the outside diameter A of the ferrule 12 is substantially equal to 2.5 millimeters.

To show the device 50 in practice, FIG. 9 is a cross-sectional side view of the ferrule 12 of FIG. 8 mated with, mounted in, or connected to the sleeve 51.

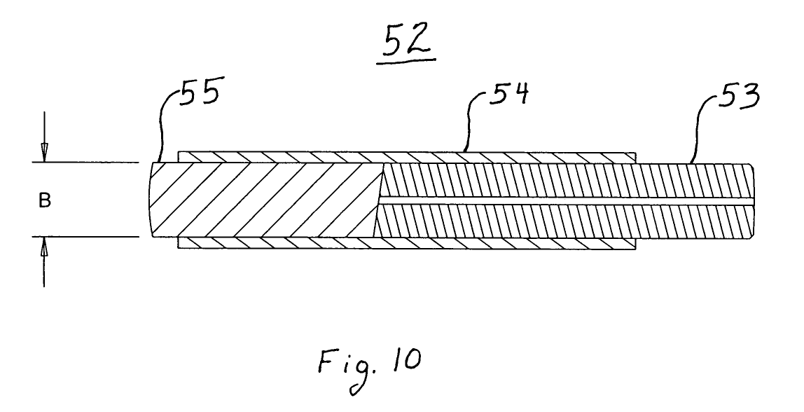

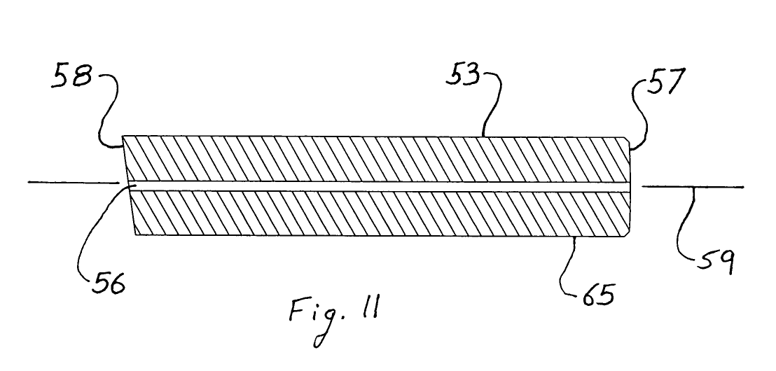

FIG. 10 is a cross-sectional side view of the stub collimator 52. The stub collimator 52 consists of fiber stub 53, a housing 54, and an aspherical lens 55 or collimating lens. The housing 54 is made of a suitable engineering material such as a metallic, glass, or ceramic material. The aspherical lens 55 is made of a suitable engineering material such a glass or glass-like material. Preferably, no gap exists between the aspherical lens 55 and the fiber stub 53. The fiber stub 53 is attached to or retained by the housing 54 by way of an epoxy material or other similar engineering adhesive material. The aspherical lens 55 is utilized since it is believed that it is easier to manufacture an aspherical lens as compared to a spherical ball lens. The aspherical lens 55 is retained by the housing 54 by way of an epoxy material. The fiber stub 53, the sleeve 51, the housing 54, and the aspherical lens 55 all generally have cylindrical shaped bodies. The aspherical lens 55 has an outside diameter identified by alphabetic character B. The diameter B can be substantially similar to the diameter A of the ferrule 12 so that it can be inserted into places where the ferrule 12 would have been inserted.

FIG. 11 is a cross-sectional side view of the fiber stub 53. The fiber stub 53 includes a stub body 65, and a discrete length of optical fiber 56. The fiber stub 53 has a first end 57, a second end 58, and a longitudinal axis 59. The discrete length of optical fiber 56 is retained in an aperture of the stub body 53 by way of an epoxy material. The first end 57 of the fiber stub 53 is polished so as to function as a physical contact ferrule. The second end of the fiber stub 53 can be perpendicular to the longitudinal axis 59 or it can be at some other angle. The fiber stub 53 generally has a cylindrical shape as rotated about the longitudinal axis 59. For reasons of clarity, in FIGS. 7, 9, 10, and 11, the cross-sectional view of the discrete length of optical fiber 56 is not shown as being cross hatched.

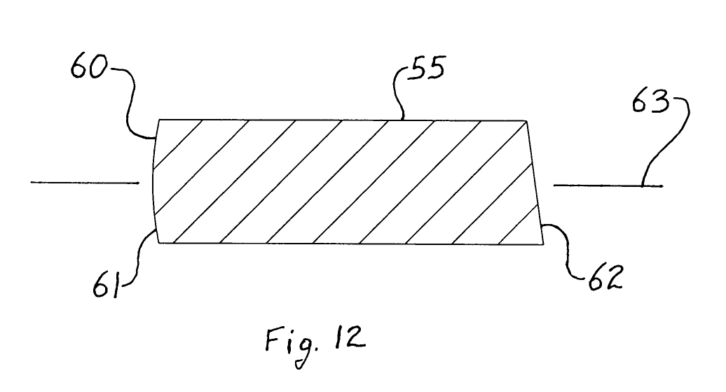

FIG. 12 is a cross-sectional side view of the aspherical lens 55. The aspherical lens 55 has a first end 61, a second end 62, an anti-reflective coating 60 applied to the first end 60, and a longitudinal axis 63. The first end 61 of the aspherical lens 55 can have a non-uniformly curved shape, and the second end 62 of the aspherical lens 55 can be perpendicular to the longitudinal axis 63 or it can be at some other angle. The aspherical lens 55 generally has a cylindrical shape as rotated about its longitudinal axis 63.

When the device is in the form as shown in FIG. 10, the longitudinal axis 63 of the aspherical lens 55 is substantially co-axial with the longitudinal axis 59 of the fiber stub 53. In the assembly of FIG. 10, the discrete length of optical fiber 56 of the fiber stub 53 is in optical communication with the aspherical lens 55 so as to enable optical communication between the two components, in either direction.

When the device is utilized as shown in FIG. 9, the optical fiber 14 of the connector is in optical communication with the discrete length of optical fiber 56 found in the fiber stub 53 of the stub collimator 52. Thus, the optical fiber 14 is in optical communication with the aspherical lens 55. The ferrule 12 is in physical contact with the first end 57 of the fiber stub 53. The ferrule 12 is fitted into the sleeve 51. The sleeve 51 can be a split ceramic sleeve or it can be a non-split sleeve, or solid sleeve, in which case the ferrule 12 is slip fitted into the sleeve 51. In practice when a light signal traverses through the core of the optical fiber 14 towards the aspherical lens 55, the light signal will expand from some size smaller than the core of the optical fiber 14 to a diameter many times the diameter of the core diameter of the optical fiber 14 as the light signal exits the aspherical lens 55. Thus, there is an expanded beam light signal, or collimated light signal. Likewise, when another device, similar to the structure as shown in FIG. 9, faces the aspherical lens 55, a light signal launched from the aspherical lens of the other device, in an expanded beam state, reaches the first surface 61 of the aspherical lens 55, the light signal travels through the aspherical lens 55 and then exits the aspherical lens 55 at its second end 62 and is focused on the core of the discrete length of optical fiber 56 found at the second end 58 of the fiber stub 53. The light signal then travels down the discrete length of optical fiber 56 so as to exit at the first end 57 of the fiber stub 53. The light signal then enters the optical fiber 14 at the ferrule 12 so as to travel the length of the optical fiber 14.

Obviously, numerous modifications and variations of the present invention are possible in light of the above teachings. It is therefore to be understood that within the scope of appended claims, the invention may be practiced otherwise than as specifically described herein.

1. A device comprising:
a fiber stub including a stub body and a discrete length of optical fiber retained by the stub body;
an aspherical lens; and
a housing, wherein the fiber stub is retained by the housing and wherein the aspherical lens is retained by the housing so that the discrete length of optical fiber of the fiber stub is in optical communication with the aspherical lens.

2. A device according to claim 1 wherein the fiber stub includes a longitudinal axis, and wherein the aspherical lens includes a longitudinal axis, and wherein the longitudinal axis of the aspherical lens is substantially coaxial with the longitudinal axis of the fiber stub.

3. A device according to claim 2, further comprising an antireflective coating applied to a surface of the aspherical lens.

4. A device according to claim 2 wherein the aspherical lens has an outside diameter.

5. A device according to claim 4 wherein the outside diameter of the aspherical lens is substantially equal to 1.25 millimeters.

6. A device according to claim 4 wherein the outside diameter of the aspherical lens is substantially equal to 2.5 millimeters.

7. A device according to claim 2 wherein one end of the stub body of the fiber stub includes a mating surface so as to enable physical contact mating with connectors.

8. A device comprising:
a fiber stub including a stub body and a discrete length of optical fiber retained by the stub body;
an aspherical lens;
a housing, wherein the fiber stub is retained by the housing and wherein the aspherical lens is retained by the housing so that the discrete length of optical fiber of the fiber stub is in optical communication with the aspherical lens; and
a sleeve having an inside diameter, and wherein the sleeve is mounted to the stub body of the fiber stub.

9. A device according to claim 8 wherein the inside diameter is sized so as to accept a ferrule of a connector having an outside diameter substantially equal to 1.25 millimeters.

10. A device according to claim 8 wherein the inside diameter is sized so as to accept a ferrule of a connector having an outside diameter substantially equal to 2.5 millimeters.

11. A device according to claim 8 wherein the fiber stub includes a longitudinal axis, and wherein the aspherical lens includes a longitudinal axis, and wherein the longitudinal axis of the aspherical lens is substantially coaxial with the longitudinal axis of the fiber stub.

12. A device according to claim 11, further comprising an antireflective coating applied to a surface of the aspherical lens.

13. A device according to claim 12 wherein the aspherical lens has an outside diameter.

14. A device according to claim 13 wherein the outside diameter of the aspherical lens is substantially equal to 1.25 millimeters.

15. A device according to claim 13 wherein the outside diameter of the aspherical lens is substantially equal to 2.5 millimeters.

16. A device according to claim 13 wherein one end of the stub body of the fiber stub includes a mating surface so as to enable physical contact mating with connectors.

17. A device comprising:
a fiber stub including a stub body and a discrete length of optical fiber retained by the stub body;
an aspherical lens;
a housing, wherein the fiber stub is retained by the housing and wherein the aspherical lens is retained by the housing so that the discrete length of optical fiber of the fiber stub is in optical communication with the aspherical lens; and
a sleeve having an inside diameter, and wherein the sleeve is mounted to the stub body of the fiber stub, and wherein the inside diameter of the sleeve is adapted to receive a ferrule which conforms to an industrial standard selected from the group consisting of LC, SC, FC, and ST industrial standards.

18. A device according to claim 17 wherein the fiber stub includes a longitudinal axis, and wherein the aspherical lens includes a longitudinal axis, and wherein the longitudinal axis of the aspherical lens is substantially coaxial with the longitudinal axis of the fiber stub.

19. A device according to claim 18, further comprising an antireflective coating applied to a surface of the aspherical lens.

20. A device according to claim 19 wherein one end of the stub body of the fiber stub includes a mating surface so as to enable physical contact mating with connectors.
